(19) United States
(12) Patent Application Publication
(10) Pub. No.: US 2017/0067790 A1
(43) Pub. Date: Mar. 9, 2017

(54) SENSOR DEVICE, PORTABLE APPARATUS, ELECTRONIC APPARATUS, AND MOVING OBJECT

(71) Applicant: Seiko Epson Corporation, Tokyo (JP)

(72) Inventor: Junichi TAKEUCHI, Chino (JP)

(21) Appl. No.: 15/249,581

(22) Filed: Aug. 29, 2016

(30) Foreign Application Priority Data
Sep. 3, 2015 (JP) 2015-173558

(51) Int. Cl. G01L 9/00; G01C 5/06; G01L 19/14; G01P 15/02; G01D 11/24

(52) U.S. Cl. CPC G01L 9/0052; G01P 15/02; G01D 11/245; G01L 19/14; G01C 5/06

(57) ABSTRACT

An electronic apparatus includes: a pressure sensor including a diaphragm portion that is deflected and deformed under pressure; an acceleration sensor that detects acceleration in a normal direction of the diaphragm portion; and a control unit that corrects a detection result of the pressure sensor using a detection result of the acceleration sensor. The acceleration sensor detects acceleration about three axes orthogonal to one another.

### BACKGROUND

1. Technical Field

The present invention relates to a sensor device, a portable apparatus, an electronic apparatus, and a moving object.

2. Related Art

Pressure sensors including a diaphragm that is deflected and deformed under pressure have been widely used. In the pressure sensor, the pressure applied to the diaphragm is detected based on, for example, the resistance values of piezoresistive elements disposed in the diaphragm (e.g., see JP-A-2011-075400).

In the related art, when acceleration such as gravitational acceleration is applied to the diaphragm, the amount of deflection of the diaphragm varies under the influence of the acceleration, and thus there is a problem in that the accuracy of detected pressure is lowered.

### SUMMARY

An advantage of some aspects of the invention is to provide a sensor device having excellent pressure detection accuracy and also provide a portable apparatus, an electronic apparatus, and a moving object including the sensor device.

The advantage can be achieved by the following aspects of the invention.

A sensor device according to an aspect of the invention includes: a pressure sensor including a diaphragm portion that is deflected and deformed under pressure; an acceleration sensor that detects acceleration in a normal direction of the diaphragm portion; and a correction unit that corrects a detection result of the pressure sensor using a detection result of the acceleration sensor.

According to the sensor device, by correcting the detection result of the pressure sensor using the detection result of the acceleration sensor, it is possible to remove or reduce an error in the detection result of the pressure sensor occurring when acceleration such as gravitational acceleration acts on an electronic apparatus. Therefore, the influence of acceleration such as gravitational acceleration is reduced, and thus the pressure can be detected with high accuracy.

In the sensor device according to the aspect of the invention, it is preferable that the acceleration sensor detects acceleration about three axes orthogonal to one another.

With this configuration, the degree of freedom of the installation posture of the acceleration sensor can be increased.

In the sensor device according to the aspect of the invention, it is preferable that the sensor device further includes a casing collectively accommodating the pressure sensor and the acceleration sensor and including an opening.

With this configuration, the pressure sensor and the acceleration sensor can be protected by the casing. Moreover, a distance between the pressure sensor and the acceleration sensor can be reduced. Therefore, the acceleration applied to the pressure sensor can be detected with high accuracy by the acceleration sensor. As a result, the detection result of the pressure sensor can be corrected with high accuracy using the detection result of the acceleration sensor.

In the sensor device according to the aspect of the invention, it is preferable that the sensor device further includes a pressure transmission medium in the form of liquid or gel filled in the casing.

With this configuration, the pressure sensor and the acceleration sensor can be protected by the pressure transmission medium while enabling pressure detection of the pressure sensor.

In the sensor device according to the aspect of the invention, it is preferable that the correction unit obtains the detection result of the pressure sensor at a first sampling frequency and obtains the detection result of the acceleration sensor at a second sampling frequency, which is a common multiple of the first sampling frequency, and that the correction unit makes corrections by synchronizing the detection result of the pressure sensor with the detection result of the acceleration sensor.

With this configuration, the detection result of the pressure sensor can be efficiently corrected using the detection result of the acceleration sensor.

In the sensor device according to the aspect of the invention, it is preferable that the pressure sensor includes a piezoresistive element provided in the diaphragm portion.

With this configuration, it is possible to realize the pressure sensor of small size and with high accuracy.

In the sensor device according to the aspect of the invention, it is preferable that the pressure sensor includes a substrate in which the diaphragm portion is provided, and a stacked structure forming a pressure reference chamber together with the substrate.

With this configuration, it is possible to realize the pressure sensor of small size and with high accuracy.

A portable apparatus according to another aspect of the invention includes the sensor device according to the aspect of the invention.

With this configuration, even when acceleration is applied to the portable apparatus, pressure can be detected with high accuracy.

In the portable apparatus according to the aspect of the invention, it is preferable that the portable apparatus is of a wristwatch-type including an exterior case in which the pressure sensor and the acceleration sensor are disposed, and a band attached to the exterior case.

Since a wristwatch-type electronic apparatus is worn on the arm of a user in use, various magnitudes of acceleration are applied in various directions according to the usage condition, and thus an error is likely to occur in the detection result of the pressure sensor. Hence, when the detection result of the pressure sensor is corrected using the detection result of the acceleration sensor in the electronic apparatus, the effect of the correction is remarkable.

In the portable apparatus according to the aspect of the invention, it is preferable that, in a plan view of the exterior case as viewed in a thickness direction, when an imaginary line passing through a center of the exterior case and extending in a direction orthogonal to an extending direction of the band is set, the pressure sensor and the acceleration sensor are both disposed on the imaginary line or both disposed on one side of the imaginary line.

With this configuration, even when the user moves the arm or wrist in various directions, the detection result of the pressure sensor can be corrected using the detection result of the acceleration sensor.

An electronic apparatus according to still another aspect of the invention includes the sensor device according to the aspect of the invention.

With this configuration, even when acceleration is applied to the electronic apparatus, pressure can be detected with high accuracy.

A moving object according to further another aspect of the invention includes the sensor device according to the aspect of the invention.

With this configuration, even when acceleration is applied to the moving object, pressure can be detected with high accuracy.

### BRIEF DESCRIPTION OF THE DRAWINGS

The invention will be described with reference to the accompanying drawings, wherein like numbers reference like elements.

FIG. 1 is a plan view showing an electronic apparatus (wristwatch-type portable apparatus) according to a first embodiment of the invention.

FIG. 2 is a block diagram of a control system of the electronic apparatus (sensor device) shown in FIG. 1.

FIG. 3 is a cross-sectional view of a sensor unit included in the electronic apparatus shown in FIG. 1.

FIG. 4 is a diagram showing a pressure sensor and an acceleration sensor included in the sensor unit shown in FIG. 3.

FIG. 5 is a graph for explaining the operation of the pressure sensor shown in FIG. 1, showing the relationship between the acceleration applied to the pressure sensor and the detected pressure.

FIG. 6 is a plan view showing an electronic apparatus (wristwatch-type portable apparatus) according to a second embodiment of the invention.

FIG. 7 is a perspective view showing an example of a moving object according to the invention.

### DESCRIPTION OF EXEMPLARY EMBODIMENTS

Hereinafter, a sensor device, a portable apparatus, an electronic apparatus, and a moving object according to the invention will be described in detail based on embodiments shown in the accompanying drawings. In the following, an example in which the electronic apparatus according to the invention is applied to a wristwatch-type portable apparatus will be described.

### 1. Electronic Apparatus

### Portable Apparatus

### First Embodiment

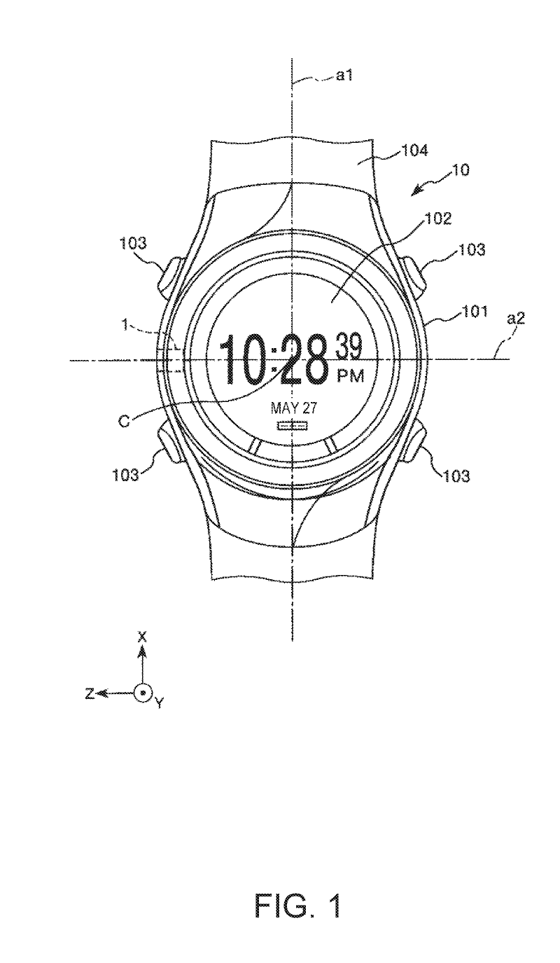

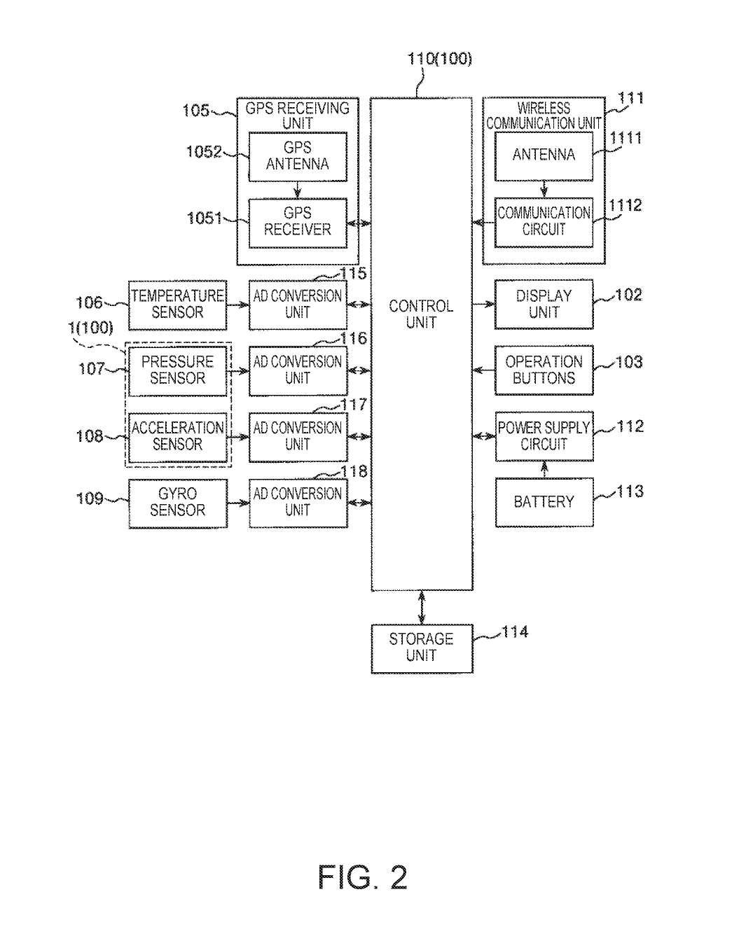

FIG. 1 is a plan view showing an electronic apparatus (wristwatch-type portable apparatus) according to a first embodiment of the invention. FIG. 2 is a block diagram of a control system of the electronic apparatus (sensor device) shown in FIG. 1. In FIG. 1, for convenience of description, an X-axis, a Y-axis, and a Z-axis are shown by arrows as three axes orthogonal to one another. The distal end side of each of the arrows is represented as “+”, and the proximal end side is represented as “−”. Moreover, a direction parallel to the X-axis is referred to as “X-axis direction”, a direction parallel to the Y-axis is referred to as “Y-axis direction”, and a direction parallel to the Z-axis is referred to as “Z-axis direction”.

The electronic apparatus 10 shown in FIG. 1 is a wristwatch-type portable apparatus. The electronic apparatus 10 includes, as shown in FIG. 1, a case 101 (exterior case), a display unit 102 provided on one surface (front surface) of the case 101, and a plurality of operation buttons 103 provided on the side surface of the case 101. Moreover, a band 104 used when the electronic apparatus 10 is worn on the arm of a user is attached to the case 101. The electronic apparatus 10 including the wristwatch-type exterior portion (the case 101 and the band 104) has excellent portability.

The case 101 has a hollow, flat shape. The display unit 102 is provided on one flat surface side of the case 101.

As shown in FIG. 2, the electronic apparatus 10 includes the display unit 102, a GPS receiving unit 105 (time-of-day information generating unit), a temperature sensor 106, a pressure sensor 107, an acceleration sensor 108, a gyro sensor 109, a wireless communication unit 111, a control unit 110, a power supply circuit 112, a battery 113, and analog-digital conversion units 115 to 118, which are accommodated in the case 101 described above. Here, a configuration including the pressure sensor 107, the acceleration sensor 108, and the control unit 110 constitutes a “sensor device 100”. The temperature sensor 106, the gyro sensor 109, the analog-digital conversion units corresponding to the temperature sensor 106 and the gyro sensor 109, and the wireless communication unit 111 may be provided as necessary, and may be omitted. Moreover, the electronic apparatus 10 may include another sensor such as a magnetic sensor, a vibrating unit having a vibration function, and a sound generating unit (speaker) that generates sounds.

The display unit 102 is configured to be able to display various kinds of information, such as time-of-day information, temperature information (outside air temperature information), barometric pressure information, position information, elevation information, gradient information, and timing information, as necessary. The display unit 102 is configured to include, for example, a display panel, such as a liquid crystal panel or an organic electroluminescence panel, and a drive circuit that drives the display panel.

The GPS receiving unit 105 (receiver) has a function of receiving a satellite signal transmitted from a GPS satellite used for a global positioning system (GPS) as one of global navigation satellite systems (GNSSs) using an artificial satellite. Moreover, the GPS receiving unit 105 performs, based on orbit information or time-of-day information superimposed on the satellite signal, processing for calculating the current position of the GPS receiving unit 105 (i.e., the current position of the electronic apparatus 10) or time-of-day information, or processing for generating an accurate timing signal (1 PPS) with which time-of-day is updated per second.

The GPS receiving unit 105 includes a GPS receiver 1051 and a GPS antenna 1052. The GPS receiver 1051 is configured to include, for example, a radio frequency (RF) unit and a baseband unit. The RF unit is configured to include, for example, a low-noise amplifier (LNA), a mixer, a voltage-controlled oscillator (VCO), a phase-locked loop (PLL) circuit, an intermediate frequency (IF) amplifier, an IF filter, and an A/D converter (ADC). The baseband unit is configured to include, for example, a digital signal processor (DSP), a central processing unit (CPU), a static random access memory (SRAM), and a real-time clock (RTC). A quartz crystal oscillation circuit with a temperature compensation circuit (temperature-compensated crystal oscillator (TCXO)), a flash memory, and the like are connected to the baseband unit.

The temperature sensor 106 has a function of detecting the temperature outside the case 101. The temperature sensor 106 is configured to include, for example, a thermocouple or a thermistor.

The pressure sensor 107 has a function of detecting the barometric pressure outside the case 101. The pressure sensor 107 is configured to include, for example, a small barometric pressure sensor manufactured using a semiconductor manufacturing technique (e.g., a MEMS-type barometric pressure sensor). The configuration of the pressure sensor 107 will be described in detail later.

The acceleration sensor 108 has a function of detecting the acceleration applied to the electronic apparatus 10 about three axes. The acceleration sensor 108 is configured to include, for example, an acceleration sensor element manufactured using a MEMS technique. The acceleration sensor 108 is unitized with the pressure sensor 107 as will be described in detail later.

The gyro sensor 109 has a function of detecting the angular velocity applied to the electronic apparatus 10 about three axes. The gyro sensor 109 is configured to include, for example, an angular velocity sensor element manufactured using a MEMS technique.

The wireless communication unit 111 has a wireless communication (transmission and reception) function. More specifically, the wireless communication unit 111 has a function of wirelessly transmitting detection results of the sensors described above or information obtained by using the detection results. With this configuration, the user can receive the information wirelessly transmitted from the wireless communication unit 111 with, for example, a host (not shown) such as a personal computer, and use the information.

The wireless communication unit 111 includes an antenna 1111 and a communication circuit 1112.

The antenna 1111 is not particularly limited but is made of, for example, a metal material, carbon, or the like, and is in the form of a winding, a thin film, or the like. The antenna 1111 may be composed of one antenna common to transmission and reception, or composed of two antennae respectively corresponding to transmission and reception.

The communication circuit 1112 includes, for example, a transmitting circuit for transmitting an electromagnetic wave, a modulating circuit having a function of modulating a signal to be transmitted, a receiving circuit for receiving an electromagnetic wave, and a demodulating circuit having a function of demodulating a signal received. The communication circuit 1112 may include a down-converter circuit having a function of converting a signal to a lower frequency signal, an up-converter circuit having a function of converting a signal to a higher frequency signal, and an amplifier circuit having a function of amplifying a signal.

Each of the analog-digital conversion units 115 to 118 includes an analog-digital conversion circuit that converts an analog signal to a digital signal. The analog-digital conversion unit 115 converts an analog signal (temperature detection signal) from the temperature sensor 106 to a digital signal. The analog-digital conversion unit 116 coverts an analog signal (pressure detection signal) from the pressure sensor 107 to a digital signal. The analog-digital conversion unit 117 converts an analog signal (acceleration detection signal) from the acceleration sensor 108 to a digital signal. The analog-digital conversion unit 118 converts an analog signal (angular velocity detection signal) from the gyro sensor 109 to a digital signal. Here, each of the analog-digital conversion units 115 to 118 performs the conversion at a predetermined sampling frequency based on a clock signal from a clock circuit (not shown). The sampling frequency may be the same or different in the analog-digital conversion units.

A storage unit 114 has a function of storing information necessary for the operation of the control unit 110.

The control unit 110 has a function of controlling the parts of the electronic apparatus 10. Specifically, for example, the control unit 110 displays, based on the information obtained from the sensors or the like included in the electronic apparatus 10, the various kinds of information, such as time-of-day information, temperature information (outside air temperature information), barometric pressure information, position information, elevation information, gradient information, and timing information, on the display unit 102 as necessary. Moreover, the control unit 110 has functions of changing the kind of information to be displayed on the display unit 102 or the display form, and switching the operating mode of the electronic apparatus 10, through the operation of the operation buttons 103.

Here, as the information displayed on the display unit 102, the detection results of the sensors may be displayed as they are, or results of making calculations, as necessary, based on the detection results may be displayed. For example, the time-of-day information is obtained from an output from the GPS receiving unit 105, or a calculation result based on the output. The temperature information is obtained from the detection result of the temperature sensor 106, or a calculation result based on the detection result. The barometric pressure information is obtained from the detection result of the pressure sensor 107, or a calculation result based on the detection result. The position information includes latitude information, longitude information, and altitude information (elevation information). The latitude information and the longitude information are obtained from calculation results based on an output from the GPS receiving unit 105, and the altitude information is obtained from a calculation result based on the detection result of the pressure sensor 107. The gradient information is obtained from a calculation result based on an output (time-of-day information, latitude information, and longitude information) from the GPS receiving unit 105 and the detection result (altitude information) of the pressure sensor 107. The timing information is obtained from a calculation result based on an output (time-of-day information) from the GPS receiving unit 105. These kinds of information are displayed singly or in combinations of two or more on the display unit 102. Moreover, the detection result of a certain sensor may be corrected based on the detection result of another sensor. For example, the altitude information can be corrected using, not only the detection result of the pressure sensor 107, but also an output (latitude information and longitude information) from the GPS receiving unit 105, the detection result (acceleration information) of the acceleration sensor 108, and the detection result (angular velocity information) of the gyro sensor 109. Moreover, since the pressure sensor 107, the acceleration sensor 108, and the gyro sensor 109 generally have temperature characteristics, the detection results of these sensors or the information obtained from the detection results can be corrected (temperature corrected) using the detection result of the temperature sensor 106 or the information obtained from the detection result. By obtaining a certain kind of information using the plurality of sensors as described above, detection accuracy can be increased.

In particular, the control unit 110 has a function as a “correction unit” that corrects the detection result of the pressure sensor 107 using the detection result of the acceleration sensor 108. With this configuration, it is possible to reduce a detection error of the pressure sensor 107 due to the acceleration applied to the pressure sensor 107.

Here, the control unit 110 obtains the detection result of the pressure sensor 107 at a first sampling frequency. Moreover, the control unit 110 obtains the detection result of the acceleration sensor 108 at a second sampling frequency, which is a common multiple of the first sampling frequency. Then, the control unit 110 makes corrections by synchronizing the detection result of the pressure sensor 107 with the detection result of the acceleration sensor 108. With this configuration, the detection result of the pressure sensor 107 can be efficiently corrected using the detection result of the acceleration sensor 108.

The control unit 110 is configured to include, for example, a central processing unit (CPU), a read only memory (ROM), a random access memory (RAM), and an input/output (I/O) port.

The power supply circuit 112 has a function of supplying power from the battery 113 to the electronic components or electronic circuits in the case 101 described above, as necessary. The battery 113 is not particularly limited, and, for example, a primary battery such as a lithium battery, or a secondary battery such as a lithium ion battery or a nickel-hydrogen battery can be used.

The power may always be supplied by the power supply circuit 112. However, when the electronic apparatus 10 includes a power switch, the supply of power may be turned on or off through the operation of the power switch. Moreover, when the electronic apparatus 10 includes a power input terminal, power may be supplied through the power input terminal when power is input through the power input terminal, and power supply from the battery 113 may be stopped.

### Sensor Unit

Hereinafter, a sensor unit 1 unitized to include the pressure sensor 107 and the acceleration sensor 108 will be described.

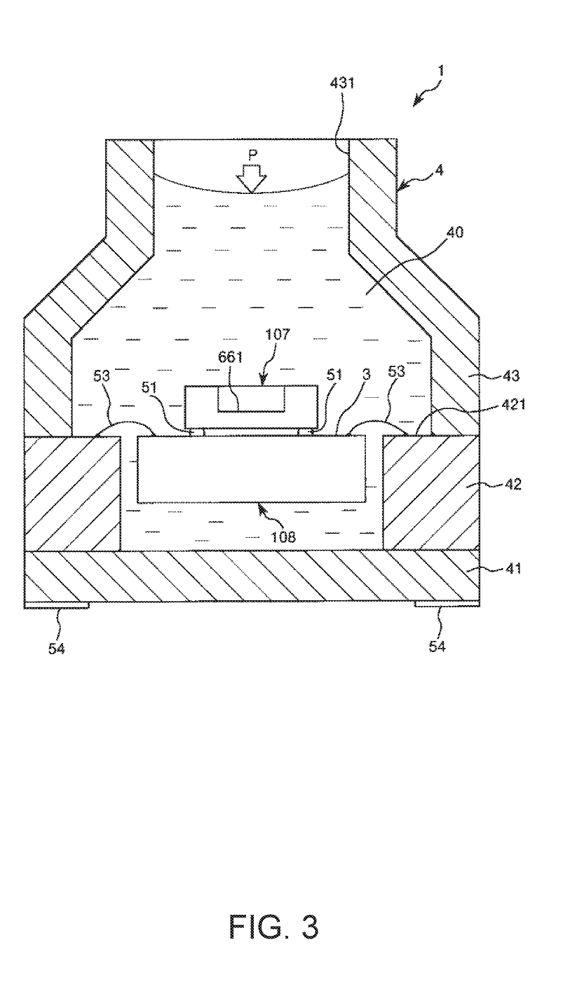

FIG. 3 is a cross-sectional view of the sensor unit included in the electronic apparatus shown in FIG. 1.

The sensor unit 1 shown in FIG. 3 includes the pressure sensor 107, the acceleration sensor 108, a casing 4 (container) collectively accommodating the pressure sensor 107 and the acceleration sensor 108, and a pressure transmission medium 40 filled in the casing 4.

The casing 4 has functions of accommodating and supporting the pressure sensor 107 and the acceleration sensor 108. With this configuration, the pressure sensor 107 and the acceleration sensor 108 can be protected.

The casing 4 includes an opening 431. With this configuration, pressure P outside the casing 4 can be transmitted through the opening 431 to the pressure sensor 107 in the casing 4.

As shown in FIG. 3, the casing 4 includes a plate-like base 41, a frame-like frame body 42 bonded to one surface of the base 41, and a tubular cylindrical body 43 bonded to a surface of the frame body 42 on the side opposite to the base 41.

A plurality of external terminals 54 made of metal are provided on the lower surface of the base 41. On the other hand, the frame body 42 is bonded to the upper surface of the base 41. The inside width of the frame body 42 is narrower than the inside width of the lower edge of the cylindrical body 43, and a step 421 is formed between the upper surface of the base 41 and the upper surface of the frame body 42. A plurality of internal terminals (not shown) made of metal are provided on the step 421. The internal terminals are electrically connected to the external terminals 54 described above via wires (not shown) embedded in the base 41 and the frame body 42.

The constituent material of the base 41 and the frame body 42 is not particularly limited. Examples thereof include, for example, insulating materials such as various kinds of ceramics like oxide ceramics such as alumina, silica, titania, and zirconia, and nitride ceramics such as silicon nitride, aluminum nitride, and titanium nitride, and various kinds of resin materials such as polyethylene, polyamide, polyimide, polycarbonate, acrylic resin, ABS resin, and epoxy resin, and one kind or two or more kinds of these materials can be used in combination. Among them, various kinds of ceramics are preferably used. With this configuration, the casing 4 having excellent mechanical strength can be realized. The plan-view shape of the base 41 and the frame body 42 is not particularly limited, and the base 41 and the frame body 42 may have, for example, a circular shape, a rectangular shape, a five- or more-sided polygonal shape, or the like.

The cylindrical body 43 includes a portion whose inside and outside widths (inside diameter and outside diameter) become narrow from the lower edge toward the upper edge, and a port ion whose inside and outside widths are constant from the narrowed portion toward the upper edge. The shape of the cylindrical body 43 is not limited to this shape. For example, the cylindrical body 43 may be composed only of the portion having the constant width or may be composed only of the portion having the width narrowed toward the upper edge.

The constituent material of the cylindrical body 43 is not particularly limited, but materials similar to the above-described constituent materials of the base 41 and the frame body 42 can be used.

The pressure transmission medium 40 is filled in the casing 4 described above so as to cover the outer surfaces (at least a pressure receiving surface 661 described later) of the pressure sensor 107 and the like, and has a function of transmitting the pressure outside the casing 4 to the pressure sensor 107.

The pressure transmission medium 40 is in the form of liquid or gel, and made of, for example, a resin material such as silicone resin. The pressure transmission medium 40 includes portion exposed through the opening 431 of the casing 4, and transmits the pressure applied to the exposed portion to the pressure sensor 107 (more specifically, the pressure receiving surface 661 of a diaphragm portion 66 described later). A filler in the form of solid (powder) made of an organic material or an inorganic material may be contained in the resin material constituting the pressure transmission medium 40.

Moreover, since the outer surfaces of the pressure sensor 107 and the acceleration sensor 108 are covered with the pressure transmission medium 40 in the form of gel or liquid, the pressure sensor 107 and the acceleration sensor 108 can be protected.

Here, the pressure sensor 107 and the acceleration sensor 108 are bonded together via bonding materials 51 such as metal bumps or conductive adhesives. With this configuration, the pressure sensor 107 is supported to the acceleration sensor 108.

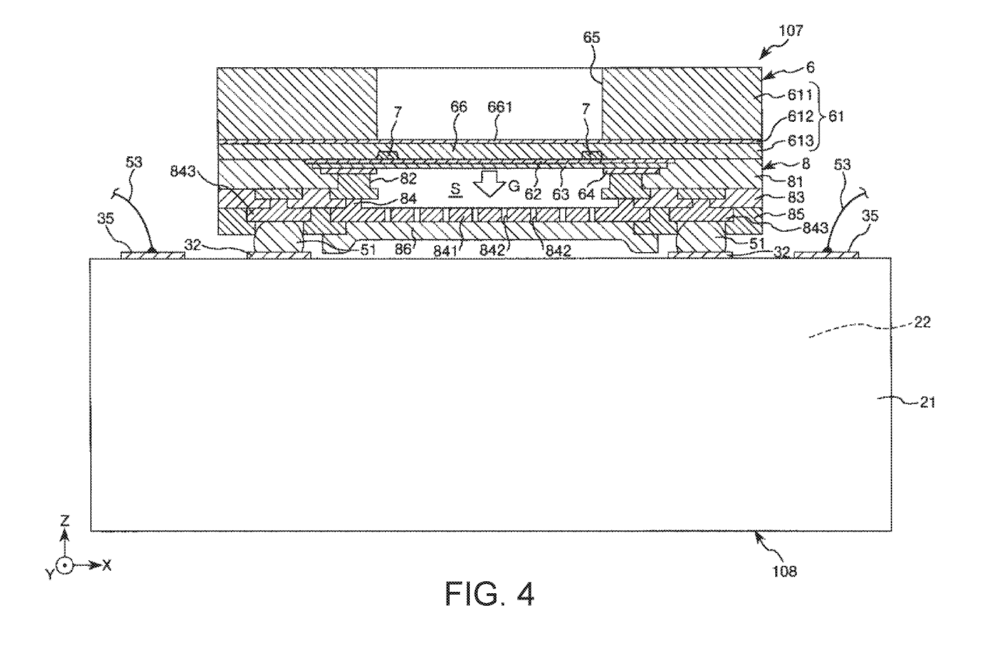

FIG. 4 is a diagram showing the pressure sensor and the acceleration sensor included in the sensor unit shown in FIG. 3. In the following, for convenience of description, the upper side (+Z-axis direction side) in FIG. 4 is referred to as “top” or “upper”, and the lower side (−Z-axis direction side) is referred to as “bottom” or “lower”.

The acceleration sensor 108 includes, as shown in FIG. 4, a package 21 and an acceleration sensor element 22 accommodated in the package 21.

The package 21 is configured by bonding, for example, a silicon substrate or glass substrate having a recess. A plurality of terminals 32 and a plurality of terminals 35 are provided on the upper surface of the package 21. The plurality of terminals 32 are connected to the pressure sensor 107 via the bonding materials 51. The plurality of terminals 35 are electrically connected to the acceleration sensor element 22 and the pressure sensor 107 via wires (not shown), and are connected to the above-described internal terminals (not shown) of the casing 4 via wires 53 composed of, for example, bonding wires. With this configuration, the acceleration sensor 108 is electrically connected to the internal terminals of the casing 4 via the wires 53, and is also supported with respect to the casing 4.

The acceleration sensor element 22 is configured to be able to detect acceleration in triaxial (e.g., the X-axis, the Y-axis, and the Z-axis) directions orthogonal to one another. With this configuration, the degree of freedom of the installation posture of the acceleration sensor 108 can be increased. The acceleration sensor element 22 is made of, for example, silicon. The acceleration sensor element 22 may be composed of one element piece capable of detecting acceleration in triaxial directions, or composed of three element pieces divided for each of the axes.

On the other hand, the pressure sensor 107 includes a substrate 6 and a stacked structure 8 provided on one major surface of the substrate 6. Here, the substrate 6 includes the diaphragm portion 66. A plurality of piezoresistive elements 7 are formed in the diaphragm portion 66. A portion of the stacked structure 8, which is disposed to face the diaphragm portion 66, is spaced from the substrate 6. With this configuration, a cavity S (pressure reference chamber) is formed between the portion and the substrate 6.

The substrate 6 includes a semiconductor substrate 61, an insulating film 62 provided on one major surface of the semiconductor substrate 61, an insulating film 63 provided on the insulating film 62 on the side opposite to the semiconductor substrate 61, and a conductor layer 64 provided on the insulating film 63 on the side opposite to the semiconductor substrate 61.

The semiconductor substrate 61 is an SOI substrate in which a silicon layer 611 (handle layer) made of single-crystal silicon, a silicon oxide layer 612 (BOX layer) made of a silicon oxide film, and a silicon layer 613 (device layer) made of single-crystal silicon are stacked in this order. The semiconductor substrate 61 is not limited to the SOI substrate, and may be any other semiconductor substrate such as, for example, a single-crystal silicon substrate.

The insulating film 62 is, for example, a silicon oxide film and has an insulating property. The insulating film 63 is, for example, a silicon nitride film, and has an insulating property and resistance to an etchant (etchant used in release etching) containing hydrofluoric acid. Here, since the insulating film 62 (silicon oxide film) lies between the semiconductor substrate 61 (the silicon layer 613) and the insulating film 63 (silicon nitride film), the transfer of stress generated in deposition of the insulating film 63 to the semiconductor substrate 61 can be reduced by the insulating film 62. Moreover, the insulating film 62 can be used as a device isolation film when a semiconductor circuit is formed on and above the semiconductor substrate 61. The insulating films 62 and 63 are not limited to the constituent materials described above. Moreover, any one of the insulating films 62 and 63 may be omitted as necessary.

The semiconductor substrate 61 is provided with a bottomed recess 65 that is opened on the side opposite to the insulating films 62 and 63 and the conductor layer 64. With this configuration, the substrate 6 is provided with the diaphragm portion 66, which is thinner than the surrounding portion and is deflected and deformed under pressure. The upper surface of the diaphragm portion 66 is the pressure receiving surface 661.

In the substrate 6 of the embodiment, the recess 65 penetrates the silicon layer 611, and the diaphragm portion 66 includes four layers, the silicon oxide layer 612, the silicon layer 613, and the insulating films 62 and 63. Here, the silicon oxide layer 612 can be used as an etching stop layer in forming the recess 65 by etching in the manufacturing process of the pressure sensor 107, so that product-by-product variations in the thickness of the diaphragm portion 66 can be reduced.

The recess 65 may not penetrate the silicon layer 611, and the diaphragm portion 66 may include five layers, a thin portion of the silicon layer 611, the silicon oxide layer 612, the silicon layer 613, and the insulating films 62 and 63.

The conductor layer 64 is configured by, for example, doping (diffusion or implantation) single-crystal silicon, polycrystalline silicon (polysilicon), or amorphous silicon with an impurity such as phosphorus or boron, and has conductivity. The conductor layer 64 is patterned, and when, for example, a MOS transistor is formed on the substrate 6 outside the cavity S, a portion of the conductor layer 64 can be used as a gate electrode of the MOS transistor. Moreover, a portion of the conductor layer 64 can be used as a wire. The conductor layer 64 is formed so as to surround the diaphragm portion 66 in the plan view, and thus forms a step portion corresponding to the thickness of the conductor layer 64. With this configuration, when the diaphragm portion 66 is deflected and deformed under pressure, stress can be concentrated on a border portion of the diaphragm portion 66 relative to the step portion. Therefore, by disposing the piezoresistive elements 7 at the border portion (or near the border portion), detection sensitivity can be improved.

The plurality of piezoresistive elements 7 are formed on the cavity S side of the diaphragm portion 66 with respect to the center of the thickness of the silicon layer 611. Moreover, the piezoresistive elements 7 are provided in the peripheral portion of the diaphragm portion 66, and extracted to the outside by means of a pair of wires (not shown). The plurality of piezoresistive elements 7 constitute a bridge circuit (Wheatstone bridge circuit), which is not shown in the drawing.

The piezoresistive elements 7 and the wires are made of, for example, silicon (single-crystal silicon) doped (diffused or implanted) with an impurity such as phosphorus or boron. Here, the doping concentration of impurity in the wire is higher than the doping concentration of impurity in the piezoresistive element 7. The wire may be made of metal.

The stacked structure 8 is formed so as to define the cavity S. The stacked structure 8 includes an inter-layer insulating film 81 formed on the substrate 6 so as to surround the piezoresistive elements 7 in the plan view, a wiring layer 82 formed on the inter-layer insulating film 81, an inter-layer insulating film 83 formed on the wiring layer 82 and the inter-layer insulating film 81, a wiring layer 84 formed on the inter-layer insulating film 83 and including a covering layer 841 including a plurality of fine pores 842 (openings), a surface protective film 85 formed on the wiring layer 84 and the inter-layer insulating film 83, and a sealing layer 86 provided on the covering layer 841.

Here, the wiring layers 82 and 84 have portions that are electrically connected to the piezoresistive elements 7. Moreover, the wiring layer 84 includes terminals 843 connected to the terminals 32 of a substrate 3 via the bonding materials 51.

As described above, since the stacked structure 8, which constitutes a portion of a wall portion of the cavity S, has a stacked structure, the stacked structure 8 can be formed using a semiconductor manufacturing process such as a CMOS process. With this configuration, the sensor unit 1 of small size can be manufactured easily and with high accuracy. Moreover, in forming the stacked structure 8, the cavity S can be formed by etching (sacrificial layer etching) through the fine pores 842. A semiconductor circuit may be fabricated on the silicon layer 613 on the side where the stacked structure 8 is disposed. The semiconductor circuit includes active elements, such as MOS transistors, and other circuit elements formed as necessary, such as capacitors, inductors, resistors, diodes, and wires (including the wires connected to the piezoresistive elements 7).

The cavity S defined by the substrate 6 and the stacked structure 8 is a hermetically sealed space. The cavity S functions as a pressure reference chamber providing a reference value of the pressure that the pressure sensor 107 detects. In the embodiment, the cavity S is in a vacuum state (300 Pa or less). By setting the cavity S into the vacuum state, the pressure sensor 107 can be used as an “absolute pressure sensor” that detects pressure with the vacuum state as a reference, so that the convenience of the pressure sensor 107 is improved.

However, the cavity S may not be in the vacuum state. The cavity S may be at atmospheric pressure, in a reduced-pressure state where the pressure is lower than atmospheric pressure, or in a pressurized state where the pressure is higher than atmospheric pressure. Moreover, an inert gas such as nitrogen gas or noble gas may be sealed in the cavity S.

In the pressure sensor 107 configured as described above, the diaphragm portion 66 is deformed in response to the pressure received by the pressure receiving surface 661 of the diaphragm portion 66. With this deformation, the piezoresistive elements 7 are strained, so that the resistance values of the piezoresistive elements 7 change. In association with the change, the output voltage of the bridge circuit including the plurality of piezoresistive elements 7 changes, and based on the output voltage, the magnitude of the pressure received by the pressure receiving surface 661 can be obtained.

As described above, the pressure sensor 107 detects the pressure based on the piezoresistive elements 7 provided in the diaphragm portion 66. Therefore, it is possible to realize the pressure sensor 107 of small size and with high accuracy.

By the way, acceleration such as gravitational acceleration is applied to the diaphragm portion 66 due to gravity, impact, or the like according to the posture of the diaphragm portion 66. Actually, therefore, the amount of deflection deformation of the diaphragm portion 66 may be different from that caused by the pressure applied to the diaphragm portion 66.

Therefore, in the electronic apparatus 10 as described above, the control unit 110 corrects the detection result of the pressure sensor 107 using the detection result (more specifically, acceleration in the normal direction of the diaphragm portion 66) of the acceleration sensor 108. With this configuration, it is possible to remove or reduce the error in the detection result of the pressure sensor 107 occurring when acceleration such as gravitational acceleration acts on the electronic apparatus 10. Therefore, the influence of acceleration such as gravitational acceleration is reduced, and thus the pressure can be detected with high accuracy.

Specifically, when downward acceleration G is applied to the diaphragm portion 66, the amount of strain of the piezoresistive elements 7 of the pressure sensor 107 is greater than the amount of strain caused only by the pressure by an amount corresponding to the acceleration G. On the other hand, when upward acceleration G is applied to the diaphragm portion 66, the amount of strain of the piezoresistive elements 7 of the pressure sensor 107 is smaller than the amount of strain caused only by the pressure by an amount corresponding to the acceleration G.

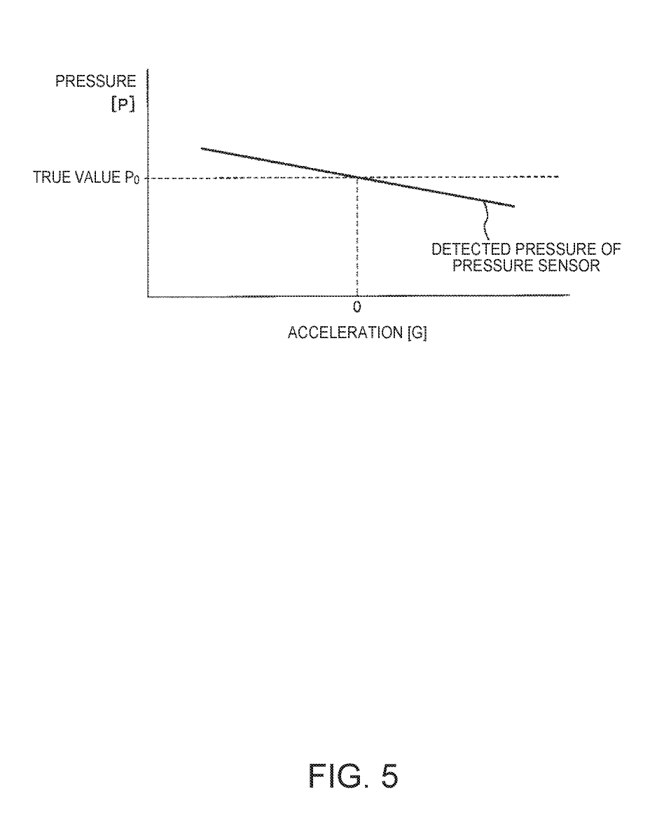

FIG. 5 is a graph for explaining the operation of the pressure sensor shown in FIG. 1, showing the relationship between the acceleration applied to the pressure sensor and the detected pressure.

When the acceleration G acts in the up-and-down direction (the thickness direction of the diaphragm portion 66) on the diaphragm portion 66 of the pressure sensor 107, the detected pressure of the pressure sensor 107 becomes smaller than an actual pressure (true value P₀) as the downward acceleration G increases as shown in FIG. 5. On the other hand, the detected pressure of the pressure sensor 107 becomes greater than the actual pressure (true value P₀) as the downward acceleration G decreases.

From the facts described above, in the electronic apparatus 10, the variation in the output of the pressure sensor 107 occurring when acceleration such as gravitational acceleration acts on the electronic apparatus 10 is computed based on the output of the acceleration sensor 108, and using a result of the computation, the detected pressure of the pressure sensor 107 is corrected so as to be close to the true value. Therefore, the influence of acceleration such as gravitational acceleration is reduced, and thus the pressure can be detected with high accuracy.

Here, as described above, the pressure sensor 107 and the acceleration sensor 108 are collectively accommodated in the casing 4. With this configuration, the pressure sensor 107 and the acceleration sensor 108 can be protected by the casing 4. Moreover, a distance between the pressure sensor 107 and the acceleration sensor 108 can be reduced. Therefore, the acceleration applied to the pressure sensor 107 can be detected with high accuracy by the acceleration sensor 108. As a result, the detection result of the pressure sensor 107 can be corrected with high accuracy using the detection result of the acceleration sensor 108.

Moreover, as described above, the electronic apparatus 10 is of the wristwatch-type, which includes the case 101 in which the pressure sensor 107 and the acceleration sensor 108 are disposed and the band 104 attached to the case 101. Since the electronic apparatus 10 of the wristwatch-type is worn on the arm of the user in use, various magnitudes of acceleration are applied in various directions according to the usage condition, and thus an error is likely to occur in the detection result of the pressure sensor 107. Hence, when the detection result of the pressure sensor 107 is corrected using the detection result of the acceleration sensor 108 in the electronic apparatus 10, the effect of the correction is remarkable.

Moreover, in the embodiment as shown in FIG. 1, in a plan view of the case 101 as viewed in the thickness direction, when an imaginary line a2 passing through a center C of the case 101 and extending in a direction (direction orthogonal to a line segment a1) orthogonal to an extending direction of the band 104 is set, the sensor unit 1 including the pressure sensor 107 and the acceleration sensor 108 is disposed on the imaginary line a2. With this configuration, even when the user moves the arm or wrist in various ways, the detection result of the pressure sensor 107 can be corrected using the detection result of the acceleration sensor 108. In particular, using the same computation for the case of a twisting motion of the arm or wrist and the case of another motion thereof, the detection result of the pressure sensor 107 can be corrected using the detection result of the acceleration sensor 108.

In the embodiment, the sensor unit 1 is disposed in a portion of the case 101 on the +Z-axis direction side; however, the sensor unit 1 may be disposed in a portion of the case 101 on the −Z-axis direction side.

### Second Embodiment

Next, a second embodiment of the invention will be described.

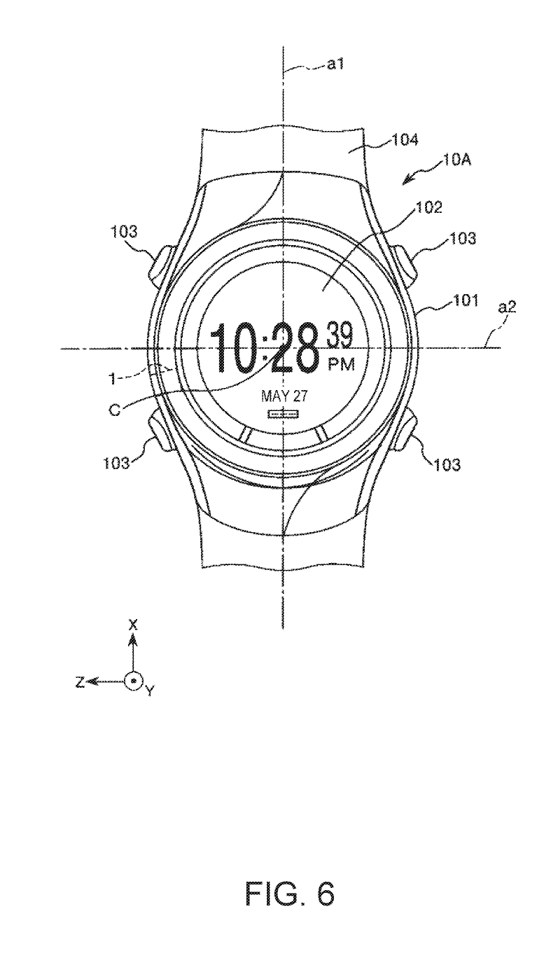

FIG. 6 is a plan view showing an electronic apparatus (wristwatch-type portable apparatus) according to the second embodiment of the invention.

Hereinafter, the second embodiment of the invention is described focusing on differences from the embodiment described above, and a description on similar matters is omitted. In FIG. 6, configurations similar to those of the embodiment described above are denoted by the same reference numerals and signs.

The second embodiment is similar to the first embodiment described above except that the arrangement of the sensor unit 1 is different.

In the electronic apparatus 10A shown in FIG. 6, in the plan view of the case 101 as viewed in the thickness direction, when the imaginary line a2 passing through the center C of the case 101 and extending in the direction (direction orthogonal to the line segment a1) orthogonal to the extending direction of the band 104 is set, the sensor unit 1 including the pressure sensor 107 and the acceleration sensor 108 is disposed on one side (the −X-axis direction side in the embodiment) of the imaginary line a2. With this configuration, even when the user moves the arm or wrist in various ways, the detection result of the pressure sensor 107 can be corrected using the detection result of the acceleration sensor 108. In particular, using the same computation for the case of a twisting motion of the arm or wrist and the case of another motion thereof, the detection result of the pressure sensor 107 can be corrected using the detection result of the acceleration sensor 108.

The sensor unit 1 may be disposed on the +X-axis direction side of the imaginary line a2 in the plan view. Moreover, in the embodiment, the sensor unit 1 is disposed in a portion of the case 101 on the +Z-axis direction side; however, the sensor unit 1 may be disposed in a portion of the case 101 on the −Z-axis direction side.

Also according to the electronic apparatus 10A described above, excellent detection accuracy can be provided.

### 2. Moving Object

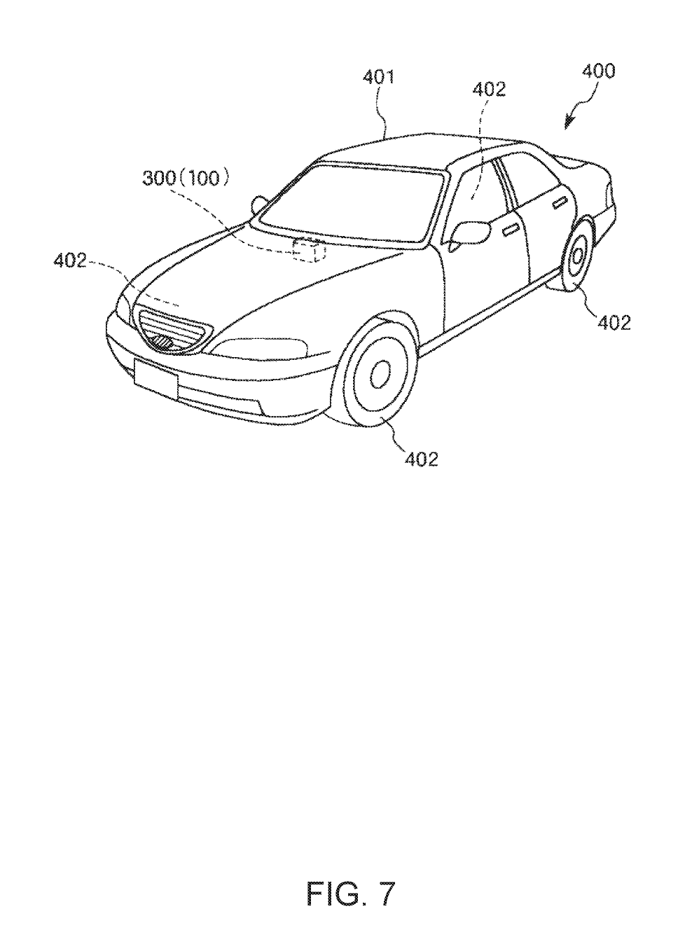

Next, a moving object (moving object according to the invention) including the pressure sensor according to the invention will be described. FIG. 7 is a perspective view showing an example of the moving object according to the invention.

As shown in FIG. 7, a moving object 400 includes a vehicle body 401 and four wheels 402, and is configured to rotate the wheels 402 with a power source (engine; not shown) provided in the vehicle body 401. A navigation system 300 (the sensor device 100) is built in the moving object 400.

According to the moving object 400, the sensor device 100 can reduce the influence of acceleration such as gravitational acceleration and thus detect pressure with high accuracy.

While the sensor device, the portable apparatus, the electronic apparatus, and the moving object according to the invention have been described above based on the embodiments shown in the drawings, the invention is not limited to these embodiments. The configuration of each part can be replaced with any configuration having a similar function. Moreover, any other configurations or processes may be added.

Moreover, in the embodiments described above, an example in which the pressure sensor and the acceleration sensor are accommodated in the same casing has been described; however, the invention is not limited to this example, and the acceleration sensor may be disposed outside the casing. In this case, the acceleration sensor is preferably disposed as close to the pressure sensor as possible.

Moreover, the configuration of the pressure sensor described above is illustrative only, and is not limited to those of the embodiments described above as long as the pressure sensor includes a diaphragm portion. For example, the pressure sensor may be one including a pressure reference chamber formed by bonding silicon substrates together.

Moreover, in the embodiments described above, the wristwatch-type apparatus (watch) has been described as an example as the portable apparatus according to the invention; however, the invention is not limited to this example, and the portable apparatus according to the invention can be applied to, for example, a mobile phone, a smartphone, a tablet terminal, and the like.

Moreover, the electronic apparatus including the sensor device according to the invention is not limited to those described above, and can be applied to, for example, a personal computer, a mobile phone, a medical device (e.g., an electronic thermometer, a sphygmomanometer, a blood glucose meter, an electrocardiogram measuring system, an ultrasonic diagnosis apparatus, and an electronic endoscope), various types of measurement instrument, indicators (e.g., indicators used in vehicles, aircraft, and ships), a flight simulator, and the like.

The entire disclosure of Japanese Patent Application No. 2015-173558, filed Sep. 3, 2015 is expressly incorporated by reference herein.

What is claimed is:

1. A sensor device comprising:
a pressure sensor including a diaphragm portion that is deflected and deformed under pressure;
an acceleration sensor that detects acceleration in a normal direction of the diaphragm portion; and
a correction unit that corrects a detection result of the pressure sensor using a detection result of the acceleration sensor.

2. The sensor device according to claim 1, wherein
the acceleration sensor detects acceleration about three axes orthogonal to one another.

3. The sensor device according to claim 1, further comprising a casing collectively accommodating the pressure sensor and the acceleration sensor and including an opening.

4. The sensor device according to claim 3, further comprising a pressure transmission medium in the form of liquid or gel filled in the casing.

5. The sensor device according to claim 1, wherein
the correction unit obtains the detection result of the pressure sensor at a first sampling frequency and obtains the detection result of the acceleration sensor at a second sampling frequency, which is a common multiple of the first sampling frequency, and
the correction unit makes corrections by synchronizing the detection result of the pressure sensor with the detection result of the acceleration sensor.

6. The sensor device according to claim 1, wherein
the pressure sensor includes a piezoresistive element provided in the diaphragm portion.

7. The sensor device according to claim 1, wherein
the pressure sensor includes
a substrate in which the diaphragm portion is provided, and
a stacked structure forming a pressure reference chamber together with the substrate.

8. A portable apparatus comprising the sensor device according to claim 1.

9. A portable apparatus comprising the sensor device according to claim 2.

10. A portable apparatus comprising the sensor device according to claim 3.

11. A portable apparatus comprising the sensor device according to claim 4.

12. The portable apparatus according to claim 8, which is of a wristwatch-type including
an exterior case in which the pressure sensor and the acceleration sensor are disposed, and
a band attached to the exterior case.

13. The portable apparatus according to claim 12, wherein
in a plan view of the exterior case as viewed in a thickness direction, when an imaginary line passing through a center of the exterior case and extending in a direction orthogonal to an extending direction of the band is set, the pressure sensor and the acceleration sensor are both disposed on the imaginary line or both disposed on one side of the imaginary line.

14. An electronic apparatus comprising the sensor device according to claim 1.

15. An electronic apparatus comprising the sensor device according to claim 2.

16. An electronic apparatus comprising the sensor device according to claim 3.

17. An electronic apparatus comprising the sensor device according to claim 4.

18. A moving object comprising the sensor device according to claim 1.

19. A moving object comprising the sensor device according to claim 2.

20. A moving object comprising the sensor device according to claim 3.
